(19) United States
(12) Patent Application Publication
(10) Pub. No.: US 2019/0317892 A1
(43) Pub. Date: Oct. 17, 2019

(54) MEMORY SYSTEM, DATA PROCESSING SYSTEM, AND OPERATING METHOD OF MEMORY SYSTEM

(71) Applicant: SK hynix Inc., Gyeonggi-do (KR)

(72) Inventor: Hui Won LEE, Gyeonggi-do (KR)

(21) Appl. No.: 16/365,025

(22) Filed: Mar. 26, 2019

(30) Foreign Application Priority Data
Apr. 16, 2018 (KR) 10-2018-0043926

(51) Int. Cl. G06F 12/02; G06F 3/06

(52) U.S. Cl. CPC G06F 12/0246; G06F 3/0604; G06F 3/0673; G06F 3/0658

(57) ABSTRACT

A memory system includes a nonvolatile memory device including a plurality of memory blocks, and a controller that generates a first mapping table for mapping information of logical addresses between a host device and physical addresses of the nonvolatile memory device and controls the first mapping table to be stored in the memory blocks. The controller may include a host interface unit that receives a second logical address to be written in a second mapping table from the host device and a second memory that stores the second mapping table.

### CROSS-REFERENCE TO RELATED APPLICATION

The present application claims priority under 35 U.S.C. § 119(a) to Korean application number 10-2018-0043926, filed on Apr. 16, 2018, in the Korean Intellectual Property Office, which is incorporated herein by reference in its entirety.

### BACKGROUND

### 1. Technical Field

Various embodiments generally relate to a method for preventing performance degradation caused by frequently accessing a nonvolatile memory device in order to acquire a mapping table.

### 2. Related Art

A memory system may be configured to store data provided from user device in response to a write request therefrom. Also, the memory system may be configured to provide stored data to the user device in response to a read request therefrom. The user device, which is capable of processing data, may be, for example, a computer, a digital camera or a mobile phone. The memory system may be disposed and operate in the user device, or may operate as a separate component that is coupled to the user device.

Since there is no mechanical driving part, such a memory system provides advantages, such as excellent stability and durability, high information access speed, and low power consumption. Memory systems having such advantages include a universal serial bus (USB) memory device, memory cards having various interfaces, a universal flash storage (UFS) device, and a solid state drive (SSD).

### SUMMARY

In an embodiment, a memory system may include a nonvolatile memory device including a plurality of memory blocks, and a controller configured to generate a first mapping table for mapping information between logical addresses of a host device and physical addresses of the nonvolatile memory device and to control the first mapping table to be stored in the memory blocks, the controller may include a host interface configured to receive from the host device a specific logical address to be written in a second mapping table from the host device, and a specific memory configured to store the specific mapping table.

In an embodiment, a data processing system may include a nonvolatile memory device including a plurality of memory blocks, a host device configured to generate a write request including a logical address corresponding to write data to be stored in the nonvolatile memory device, and a controller configured to receive the write request from the host device, to generate a first mapping table including mapping information of the logical address and a physical address between the nonvolatile memory device, and to control the first mapping table to be stored in the memory blocks, wherein the write request may include information regarding whether the logical address is a second logical address, and the controller may include a specific memory in which a specific mapping table including mapping information of the specific logical address is stored when the logical address is the specific logical address.

In an embodiment, an operating method of a memory system may include the steps of receiving a specific logical address to be written in a second mapping table from a host device, writing mapping information of the second logical address in the second to mapping table, and storing the second mapping table in a second memory, wherein the second mapping table may be fixed to the specific memory.

In an embodiment, A memory system comprising: a memory device; and a controller, including a memory, suitable for: receiving a request and a logical address from a host device, the request including information indicating whether the logical address is a set logical address; determining whether the logical address is the set logical address based on the information; generating a mapping table to store mapping information between the logical address and a physical address of the memory device that corresponds to the logical address, when it is determined that the logical address is the set logical address; and storing the mapping table in the memory.

Accordingly, in a memory system in accordance with embodiments, mapping information of a logical address at which a read operation is frequently performed is fixed to an internal memory of the controller, so that it is possible to reduce the number of accesses to the nonvolatile memory device in order to acquire a mapping table.

### BRIEF DESCRIPTION OF THE DRAWINGS

FIG. 1 is a block diagram schematically illustrating a data processing system in accordance with an embodiment.

FIG. 2A and FIG. 2B are diagrams schematically illustrating examples of a mapping table and a specific mapping table, respectively.

FIG. 3 is a flowchart schematically illustrating an operation of a memory system or a data processing system in accordance with an embodiment.

FIG. 4A is a diagram illustrating information included in a read request received from a host device in accordance with an embodiment.

FIG. 4B is a flowchart schematically illustrating an operation of a memory system or a data processing system in accordance with an embodiment.

FIG. 5A is a diagram illustrating information included in a write request received from a host device in accordance with an embodiment.

FIG. 5B is a flowchart schematically illustrating an operation of a memory system or a data processing system in accordance with an embodiment.

FIG. 6 is a diagram schematically illustrating a data processing system including a solid state drive (SSD) in accordance with an embodiment.

FIG. 7 is a diagram schematically illustrating a data processing system including a memory system in accordance with an embodiment.

FIG. 8 is a diagram schematically illustrating a data processing system including a memory system in accordance with an embodiment.

FIG. 9 is a diagram schematically illustrating a network system including a memory system in accordance with an embodiment.

FIG. 10 is a block diagram schematically illustrating a nonvolatile memory device included in a memory system in accordance with an embodiment.

### DETAILED DESCRIPTION

Advantages, features and methods for achieving the present invention will become more apparent from the following embodiments described in conjunction with the drawings. Elements and features of the present invention, however, may be configured or arranged differently to form other embodiments, which may be variations or modifications of any of the disclosed embodiments. Thus, the present invention is not limited to the embodiments set forth herein. Rather, these embodiments are provided to describe the present invention in detail to the extent that a person skilled in the art to which the invention pertains can easily practice the present invention. Throughout the disclosure, like reference numerals refer to like parts throughout the various figures and embodiments of the present invention. It is noted that reference to “an embodiment” or the like does not necessarily mean only one embodiment, and different references to “an embodiment” or like phrase are not necessarily to the same embodiment(s).

It is to be understood that embodiments of the present to invention are not limited to the particulars shown in the drawings and that the drawings are not necessarily to scale and in some instances proportions may have been exaggerated in order to more clearly depict certain features of the invention. While particular terminology is used herein, it is to be appreciated that such terminology is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms and vice versa, unless the context clearly indicates otherwise. It will be further understood that the open-ended terms, e.g., “includes” and/or “including,” when used in this specification, specify the presence of at least one stated feature, step, operation, and/or element, but do not preclude the presence or addition of one or more other features, steps, operations, and/or elements thereof.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

Various embodiments of a memory system, a data processing system, and an operating method of the memory system are described below with reference to the accompanying drawings.

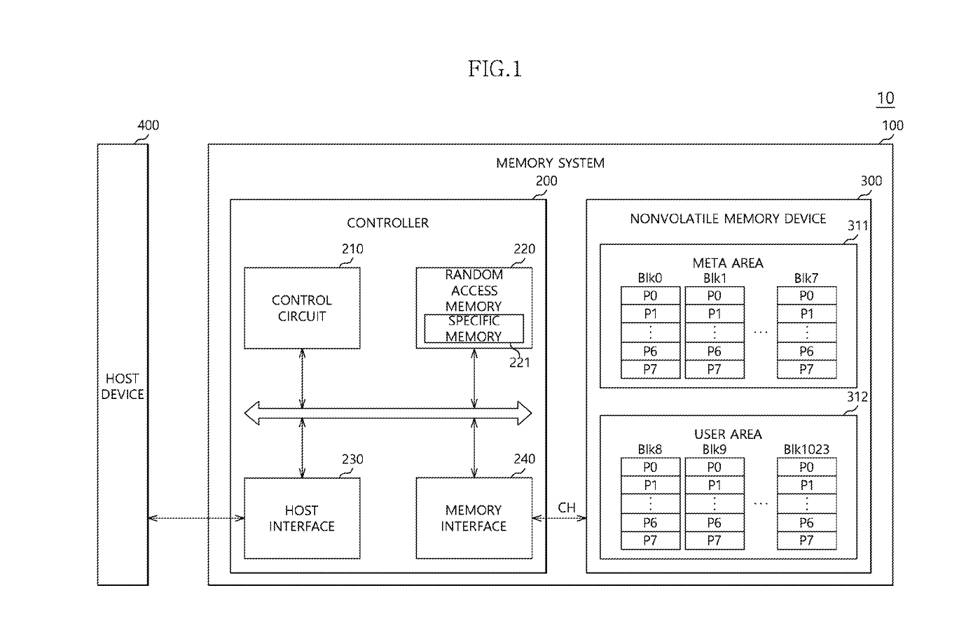

FIG. 1 is a block diagram schematically illustrating a data processing system in accordance with an embodiment.

Referring to FIG. 1, a data processing system 10 may include a memory system 100 and a host device 400. The memory system 100 may store data which is accessed by the host device 400, which may be any of a wide variety of devices, such as a cellular phone, an MP3 player, a laptop computer, a desktop computer, a game machine, a television, and an in-vehicle infotainment system.

The memory system 100 may be configured as any one of various types of storage devices according to a host interface indicating a transfer protocol with the host device 400. For example, the memory system 100 may be configured as any one of a solid state drive (SSD), a multimedia card in the form of an MMC, an eMMC, an RS-MMC, or a micro-MMC, a secure digital card in the form of an SD, a mini-SD, or a micro-SD, a universal serial bus (USB) storage device, a universal flash storage (UFS) device, a storage device in the form of a personal computer memory card international association (PCMCIA) card, a storage device in the form of a peripheral component interconnection (PCI) card, a storage device in the form of a PCI express (PCI-e or PCIe) card, a compact flash (CF) card, a smart media card, and a memory stick.

The memory system 100 may be fabricated as any one of various types of packages. For example, the memory system 100 may be fabricated as any one of a package on package (PoP), a system in package (SIP), a system on chip (SoC), a multi-chip package (MCP), a chip on board (COB), a wafer-level fabricated package (WFP), and a wafer-level stack package (WSP).

The memory system 100 may include a controller 200. The controller 200 may include a control circuit 210, a random access memory 220, a host interface 230, and a memory interface 240.

The control circuit 210 may be configured with an appropriate combination of hardware and software and may be implemented as a micro control unit (MCU) and/or a central processing unit (CPU). The control circuit 210 may process a request received from the host device 400. In order to process the request, the control circuit 210 may execute a code type of instruction or algorithm loaded on the random access memory 220, that is, firmware (FW), and control internal functional blocks and a nonvolatile memory device 300.

The random access memory 220 may include a random access memory such as a dynamic random access memory (DRAM) and a static random access memory (SRAM). The random access memory 220 may store the firmware (FW) to be executed by the control circuit 210. Furthermore, the random access memory 220 may store data required for executing the firmware (FW), for example, meta data. That is, the random access memory 220 may operate as a working memory of the control circuit 210.

The random access memory 220 may include a specific memory 221. The specific memory 221 may include a static random access memory (SRAM); however, neither this embodiment nor the invention as a whole is limited thereto, as the specific memory 221 may include any of various types of random access memories. The control circuit 210 may store a specific mapping table, which includes mapping information of specific logical addresses set by a request of the host device 400, in the specific memory 221. Further, the control circuit 210 may perform a read operation for data corresponding to a specific logical address with reference to the specific memory 221. A process in which the specific mapping table is generated and is stored in the specific memory 221 and the read operation is performed based on the specific mapping table will be described in detail below.

The random access memory 220 may be used as a buffer that temporarily stores data. For example, the random access memory 220 may read data, corresponding to a read request of the host device 400, from the nonvolatile memory device 300, temporarily store the read data, and then transmit the read data to the host device 400. Furthermore, the random access memory 220 may receive write data, corresponding to a write request of the host device 400, from the host device 400, temporarily store the write data, and then transmit the write data to the nonvolatile memory device 300.

The controller 200 may include a read only memory (ROM) (not illustrated). The ROM may include a mask ROM, a programmable ROM (PROM), an erasable programmable ROM (EPROM) and the like.

The host interface 230 may provide interfacing between the host device 400 and the memory system 100. For example, the host interface 230 may communicate with the host device 400 by using at least one of standard transfer protocols, such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-e or PCIe), and a universal flash storage (UFS).

The memory interface 240 may control the nonvolatile memory device 300 under the control of the control circuit 210. The memory control interface 240 may provide control signals to the nonvolatile memory device 300. The control signals may include a command, an address, a control signal and the like for controlling the nonvolatile memory device 300. The memory control interface 240 may provide data to the nonvolatile memory device 300 or receive data from the nonvolatile memory device 300.

The nonvolatile memory device 300 may be configured as any one of various types of nonvolatile memory devices such as a NAND flash memory device, a NOR flash memory device, a ferroelectric random access memory (FRAM) using a ferroelectric capacitor, a magnetic random access memory (MRAM) using a tunneling magneto-resistive (TMR) film, a phase change random access memory (PCRAM) using chalcogenide alloys, and a resistive random access memory (ReRAM or RRAM) using a transition metal oxide.

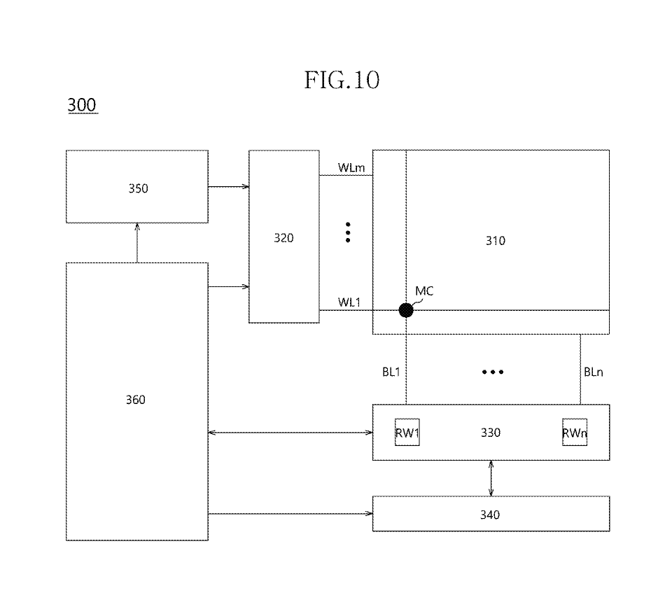

The nonvolatile memory device 300 may include a memory cell array (e.g., a memory cell array 310 of FIG. 10) Memory cells included in the memory cell array 310 may be configured in units of hierarchical memory cell sets or memory cells in an operational aspect or a physical (or structural) aspect. For example, memory cells electrically connected to the same word line and simultaneously read and written (or programmed) may be configured as a page. Hereinafter, memory cells configured as a page are called a “page”. Furthermore, memory cells simultaneously deleted may be configured as a memory block. The memory cell array 310 may include a plurality of memory blocks, wherein each of the memory blocks may include a plurality of pages.

The memory cell array 310 may include a meta area 311 where meta data is stored and a user area 312 where normal data such as user data is stored. The meta area 311 may store various types of information for substantially managing the data stored in the user area 312, and in an example, a mapping table including mapping information of logical addresses and physical addresses may be stored in the meta area 311.

Information regarding the mapping table may be exchanged between the controller 200 and the nonvolatile memory device 300. For example, when the memory system 100 is driven, the mapping table stored in the meta area 311 is provided to the controller 200, so that the controller 200 may manage a memory operation for the nonvolatile memory device 300 with reference to the address mapping information. Furthermore, the controller 200 may change the mapping table according to a memory operation or a memory management operation such as garbage collection, and may manage the changed mapping table to be stored in the meta area 311.

The meta area 311 may include a plurality of mapping tables. For example, the memory cell array 310 may include a plurality of areas each having a set or predetermined size and the meta area 311 may include a plurality of mapping tables corresponding to the plurality of areas.

By way of example, the follow ng configuration is assumed. As illustrated in FIG. 1, each of the memory blocks included in the nonvolatile memory device 300 includes eight pages P0 to P7, the meta area 311 is set to memory blocks BIk0 to Blk7, and the user area 312 is set to memory blocks Blk8 to Blk1023.

Recently, as a nonvolatile memory device is frequently used in a portable terminal in an environment in which miniaturization is required, the typical number of embedded volatile memories (for example, SRAMs) utilized as a buffer is not sufficient. Therefore, when a mapping table including mapping information between logical to addresses of a host device and physical addresses of the nonvolatile memory device is stored in a meta area of the nonvolatile memory device and a read request of the host device is received, since a mapping table for data requested to be read is read from the nonvolatile memory device and a read operation is performed based on the mapping table, there is a concern that system performance may be reduced.

In order to solve such a concern, a method is provided, in which a recently used mapping table having a certain size is temporarily stored in a cache area and corresponding mapping information is acquired with reference to the cache area when there a read request for an area in the mapping table stored in the cache area. However, when data recently requested to be read is distributed in an area stored in the nonvolatile memory device, even though the data is frequently requested to be read, due to the size (or capacity) of the limited cache area, it is often necessary to access the memory device again to acquire the mapping table.

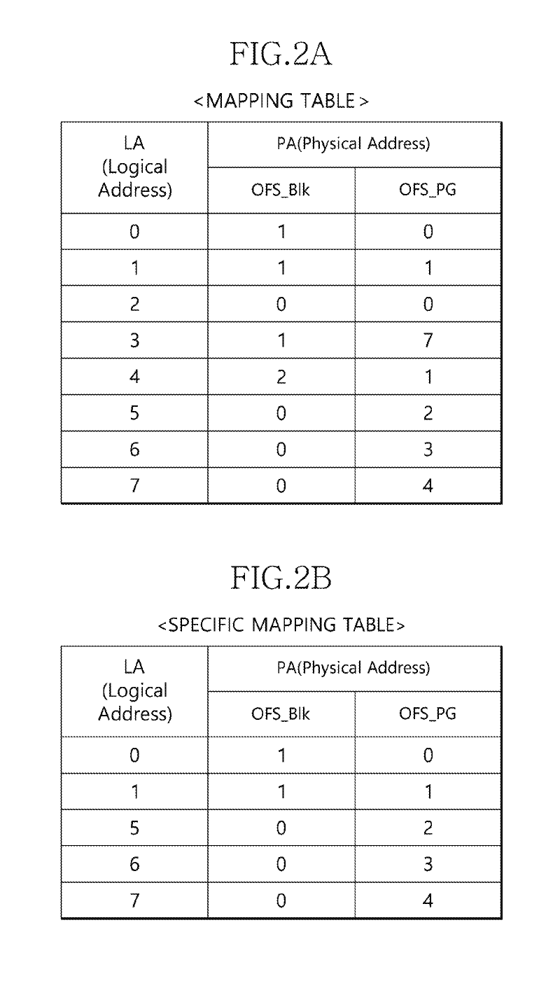

FIG. 2A and FIG. 2B are diagrams schematically illustrating a mapping table and a specific mapping table, respectively.

In accordance with an embodiment, the controller 200 may generate a logical-to-physical (L2P) mapping table or a physical-to-logical (P2L) mapping table on the basis of address mapping information. In the L2P mapping table, logical addresses are set to indexes and physical addresses mapped to the logical addresses are set to entries. In the P2L mapping table, physical addresses are set to indexes and logical addresses mapped to the physical addresses are set to entries. In the context of the description below, the L2P mapping table is described as an example of the mapping table; however, the present invention is not limited thereto, as the mapping table may be implemented as the P2L mapping table in accordance with another embodiment.

Referring to FIG. 2A, the controller 200 may generate a mapping table on the basis of address mapping information. In accordance with an embodiment, a position in the nonvolatile memory device 300, at which data has been stored, that is, a physical address may be indicated by a block offset OFS_Blk and a page offset OFS_PG. Hereinafter, the physical address is indicated by a physical address PA (OFS_Blk and OFS_PG).

As illustrated in FIG. 2A, a physical address PA (1, 0), a physical address PA (1, 1), a physical address PA (0, 0), a physical address PA (1, 7), a physical address PA (2, 1), a physical address PA (0, 2), a physical address PA (0, 3), and a physical address PA (0, 4) have been mapped to a logical address LA0 to a logical address LA7, respectively.

Referring to FIG. 2B, the host device 400 may transmit information on a specific logical address to the controller 200. The controller 200 may generate a specific mapping table for mapping information of the specific logical address on the basis of the information. Furthermore, the controller 200 may store the generated specific mapping table in a separate area (for example, the to specific memory 221) of the random access memory 220. That is, in the present specification, the “specific logical address” indicates a logical address that is the target of mapping information to be fixedly stored in an internal memory of the controller 200. Furthermore, the “specific mapping table” indicates a mapping table including the mapping information on the specific logical address. Furthermore, the “specific memory” is disposed within the controller 200 and stores the specific mapping table.

In accordance with an embodiment, the specific logical address may correspond to data for driving an operating system (OS) of the host device 400. The data for driving the OS is highly likely to be data that is essentially used when the host device 400 is used. That is, since it is data to be frequently accessed, when the data is fixedly stored in the internal memory of the controller 200, it is possible to remarkably reduce the number of accesses to the nonvolatile memory device 300 in order to acquire a mapping table, resulting in improvement of system performance.

In accordance with an embodiment, the specific logical address may correspond to data for a user authentication operation of the host device 400. For example, the user authentication operation may include user login information such as a user identifier (ID), a password, and/or other authentication information used for receiving a service from a cloud server and the like, or information for communication authentication. Such a user authentication operation is often for driving the host device 400, and thus the possibility of frequent access is high.

In accordance with an embodiment, the controller 200 may store the information on the specific logical address in an area other than the specific memory 221. When a read request is received from the host device 400, the controller 200 may determine whether a logical address corresponding to the read request is the specific logical address with reference to the information on the specific logical address. In such a case, the “information on the specific logical address” may include a list of logical addresses set to specific logical addresses by the host device 400.

For example, as illustrated in the drawings, the logical address LA0, the logical address LA1, the logical address LA5, the logical address LA6, and the logical address LA7 have been set to specific logical addresses by the host device 400, the specific mapping table has been generated by the controller 200, and the generated specific mapping table has been stored in a specific memory. Accordingly, the specific mapping table indicates mapping information of the specific logical addresses.

As illustrated in the drawings, the specific mapping table indicating the logical addresses and the physical addresses has been exemplified, but the present invention is not limited to the arrangement, as this feature may also be implemented by a mapping table indicating other information. For example, when a continuous specific logical address is set, it may be indicated by a start logical address (or a start physical address) and the number of continuous to addresses (that is, the length of the address).

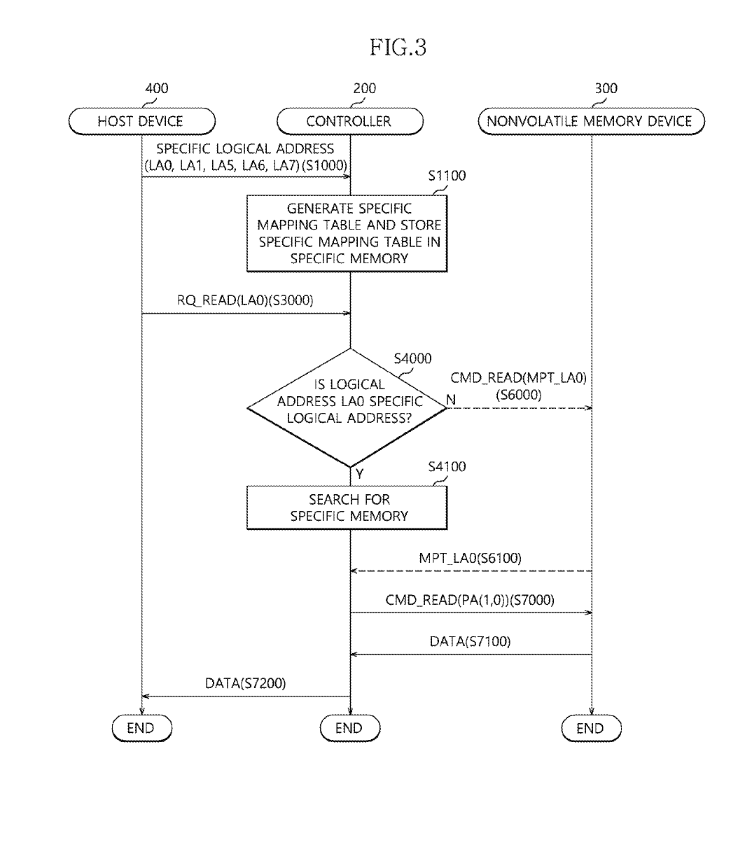

FIG. 3 is a flowchart schematically illustrating an operation of a memory system or a data processing system, e.g., the memory system 100 or the data processing system 10 of FIG. 1, in accordance with an embodiment. With reference to FIG. 1, FIG. 2A, FIG. 2B, and FIG. 3, a read operation for data corresponding to a specific logical address will be described below.

Referring primarily to FIG. 3, at step S1000, the host device 400 may transmit a list of logical addresses set to specific logical addresses to the controller 200. That is, the host device 400 may transmit specific logical addresses set in advance to the controller 200. The time of transmission may be after the memory system 100 booted. As illustrated in FIG. 2B, the logical addresses LA0, LA1, LA5, LA6, and LA7 have been set to the specific logical addresses.

At step S1100, the controller 200 may generate a specific mapping table including mapping information of the specific logical addresses received from the host device 400, and store the specific mapping table in the specific memory 221. For example, the specific mapping table of FIG. 2B is stored in the specific memory 221.

At step S3000, the host device 400 may generate a read request RQ_READ (LA0) for data corresponding to the logical address LA0 and transmit the read request RQ_READ (LA0) to the controller 200. That is, the host device 400 may transmit the read request for the data corresponding to the logical address LA0 set to the specific logical address to the memory system 100.

At step S4000, the controller 200 may determine whether the logical address, which is the target of the read request received from the host device 400, is the specific logical address. In accordance with an embodiment, the controller 200 may store information on the specific logical addresses in an area other than the specific memory 221. When a read request is received from the host device 400, the controller 200 may determine whether a logical address corresponding to the read request is the specific logical address with reference to the information on the specific logical addresses. For example, after a logical address to be set to the specific logical address is received from the host device 400, the controller 200 may store a list of the specific logical addresses in an area (for example, the ROM) other than the specific memory 221. As indicated above, since the logical address LA0, which is the target of the read request LA0 of the host device 400, is in the list, it is determined to be the specific logical address.

At step S4100, the controller 200 may search for the specific memory 221 when it is determined that the logical address, which is the target of the read request, is the specific logical address (S4000, Y). Specifically, the controller 200 may acquire mapping information of the logical address LA0 with reference to the specific mapping table stored in the specific memory 221, and acquire a physical address corresponding to the logical address LA0.

If it is determined that the logical address LA0 is not the specific logical address (54000, N), at step S6000, the controller 200 may transmit a read command CMD_READ (MPT_LA0) to the nonvolatile memory device 300 in order to acquire a mapping table MPT_LA0 including the mapping information of the logical address LA0. That is, when it is determined that the logical address, which corresponds to the target of the read operation, is not the specific logical address, no mapping information is stored in the specific memory 221, and in order to acquire the mapping information, it is necessary to read a mapping table stored in the nonvolatile memory device 300 and to determine mapping information.

At step S6100, the nonvolatile memory device 300 may read the mapping table MPT_LA0 from an area stored with the mapping table MPT_LA0 in correspondence to the read command CMD_READ (MPT_LA0) of the contorller 200, and transmit the mapping table MPT_LA0 to the controller 200.

At step S7000, the controller 200 may transmit a read command CMD_READ (PA (1, 0)) to the nonvolatile memory device 300 on the basis of a physical address determined based on the mapping table MPT_LA0 acquired from the specific memory 221 (step S4100) or the nonvolatile memory device 300 (step S6100). At step S7100, the nonvolatile memory device 300 may transmit target data of the read operation to the controller 200. The target data may be stored in the random access memory 220 (or a buffer memory) of the controller 200. At step S7200, the target data is transmitted to the host device 400, so that the read operation is ended.

In accordance with an embodiment, when a specific mapping table including mapping information of a specific logical address set in advance by the host device 400 is fixedly stored in the specific memory 221 and the mapping information of the specific logical address is acquired with reference to the specific memory 221 in the read operation for the specific logical address, it is possible to reduce the number of accesses to the nonvolatile memory device 300 in order to acquire the mapping information, so that the performance of the read operation can be improved. Particularly, a logical address, at which the read operation is frequently performed, is set to the specific logical address and is fixed in the specific memory 221, so that it is possible to more efficiently use the memory system 100.

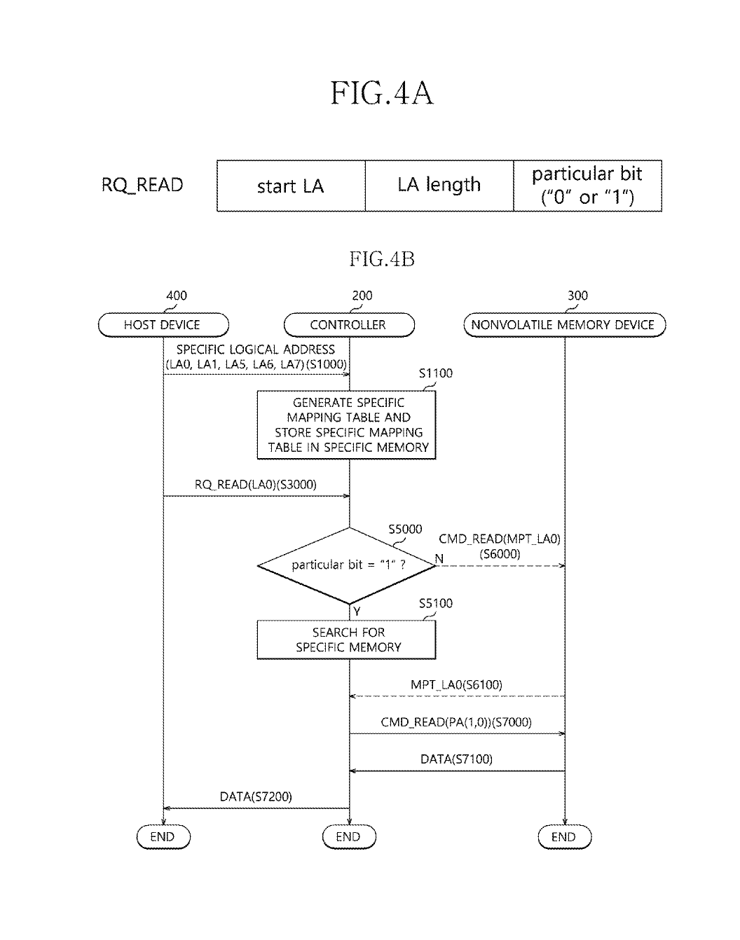

FIG. 4A is a diagram for illustrating information included in a read request received from a host device (e.g., the host device 400 of FIG. 1) in accordance with an embodiment.

In accordance with an embodiment, the host device 400 may generate a read request RQ_READ including information regarding whether the logical address, which is the target of the read operation, is the specific logical address. For example, as illustrated in the drawing, the host device 400 may generate the read request RQ_READ including a bit (i.e., particular bit “0” or “1”) indicating whether the logical address is the specific logical address. In accordance with an embodiment, in the read request RQ_READ, the logical address, which corresponds to data that is the target of the read operation, may be indicated by a start logical address (start LA) and the length or the number of the logical address (LA length). For to example, when the logical address LA5 to the logical address LA7 are logical addresses, which are the target of the read request, the “start LA” is 5 and the “LA length” is 3.

In accordance with an embodiment, the particular bit may indicate whether the logical address is the specific logical address. For example, when the logical address is not the specific logical address, the particular bit may be represented by “0”, and when the logical address is the specific logical address, the particular bit may be represented by “1”. When the read request RQ_READ generated and outputted from the host device 400 includes whether the logical address is the specific logical address, information on the specific logical address may not be separately stored in and managed by the controller 200.

FIG. 4B is a flowchart schematically illustrating an operation of a memory system or a data processing system, e.g., the memory system 100 or the data processing system 10 of FIG. 1, in accordance with an embodiment. With reference to FIGS. 1, 2A, 2B, 3, 4A and 4B, a process, in which a read operation is performed when a read request including the information regarding whether the logical address is the specific logical address is received from the host device 400, will be described in detail below.

Referring to FIG. 4B, step S1000 and step S1100 may be performed in the same manner as described with reference to FIG. 3. That is, a list of logical addresses set to specific logical addresses may be received from the host device 400 (step S1000), a specific to mapping table corresponding to the list may be generated, and the generated specific mapping table may be stored in the specific memory 221 (step S1100).

At step S3000, the controller 200 may receive a read request RQ_READ (LA0) from the host device 400. The read request may include the information illustrated in FIG. 4A. That is, the controller 200 may receive the read request RQ_READ (LA0), which includes the bit indicating whether the logical address is the specific logical address, from the host device 400.

At step S5000, the controller 200 may determine whether the particular bit included in the read request RQ_READ (LA0) is “1”. By way of example, when the particular bit is “0”, the logical address not the specific logical address, and when the particular bit is “1”, the logical address is a logical address set to the specific logical address. Since the logical address LA0, which is the target of the read request RQ_READ (LA0) is the specific logical address, the particular bit is “1”. As those skilled in the art understand, the logic associated with whether logical address is or is not the specific logical address may be reversed. That is, a “0” value of the particular bit may be used to indicate that the logical address is the specific logical address, and a value of “1” of the particular bit may be used to indicate the logical address is not the specific logical address.

At step S5100, when it is determined that the logical address, which is the target of the read request is the specific logical address (step S5000, Y), the controller 200 may search for the to specific memory 221. Specifically, the controller 200 may acquire mapping information of the logical address LA0 with reference to the specific mapping table stored in the specific memory 221, and acquire a physical address corresponding to the logical address LA0.

If the particular bit is not “1” (step S5000, N), that is, it is “0”, at step S6000, the controller 200 may transmit a read command CMD_READ (MPT_LA0) to the nonvolatile memory device 300 in order to acquire a mapping table MPT_LA0 including the mapping information of the logical address LA0. That is, when the particular bit is not “1”, since the logical address, which corresponds to the target of the read operation, is not the specific logical address, no mapping information may be stored in the specific memory 221. Accordingly, in order to acquire the mapping information, it is necessary to read a mapping table stored in the nonvolatile memory device 300 and to determine mapping information of the corresponding logical address.

Subsequent steps S6100, S7000, S7100, and S7200 may be performed in the same manner as described with reference to FIG. 3. That is, the controller 200 may receive the mapping table MPT_LA0 from the nonvolatile memory device 300 (step S6100), generate a read command CMD_READ (PA (1, 0)) on the basis of the mapping table MPT_LA0, and transmit the read command CMD_READ (PA (1, 0)) to the nonvolatile memory device 300 (step S7000). The nonvolatile memory device 300 may transmit data corresponding to the read command CMD_READ (PA (1, 0)) to the controller 200 (step S7100). The controller 200 temporarily stores the data in the random access memory 220 and then transmits the data to the host device 400 (step S7200), so that the operation for the logical address LA0 is ended.

As described above, when the host device 400 generates a read request including information indicating whether the logical address, which is the target of the read operation, is the specific logical address, and transmits the read request to the controller 200, the number of accesses to the nonvolatile memory device 300 in order to acquire mapping information is reduced and the controller 200 does not need to separately store information on the specific logical address. Thus, it is possible to minimize the use of the internal memory of the controller 200.

In various embodiments, as shown in FIG. 1, the data processing system 10 may include the nonvolatile memory device 300 including a plurality of memory blocks, and the host device 400 that generates a write request including a logical address corresponding to write data to be stored in the nonvolatile memory device 300. Further, the data processing system 10 may include the controller 200 that receives the write request from the host device 400, generates a mapping table including mapping information of a logical address and a physical address of the nonvolatile memory device 300 and controls the mapping table to be stored in the memory blocks of the nonvolatile memory device 300. The write request may include information regarding whether the logical to address is the specific logical address.

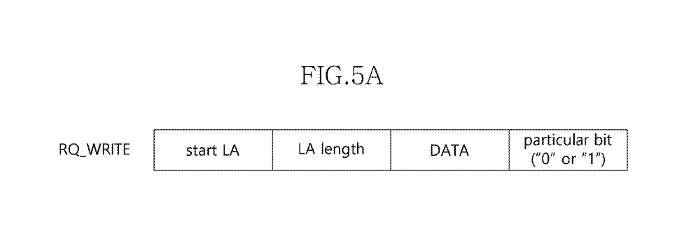

FIG. 5A is a diagram illustrating information included in a write request received from a host device (e.g., the host device 400 of FIG. 1) in accordance with an embodiment.

Referring to FIG. 5A, the host device 400 may generate a write request RQ_WRITE including information regarding whether a logical address, which is the target of a write operation, is a specific logical address, logical address information, and data as the target of the write operation. For example, as illustrated in the drawing, the host device 400 may generate the write request RQ_WRITE including a bit (i.e., a particular bit “0” or “1”) indicating whether the logical address is the specific logical address. In accordance with an embodiment, in the write request RQ_WRITE, a logical address, which corresponds to data that is the target of the write operation, may be indicated by a start logical address (start LA) and the length or the number of the logical address (LA length). For example, when the logical address LA0 to the logical address LA7 are logical addresses, which are the target of the write operation, the “start LA” is 0 and the “LA length” is 8.

In accordance with an embodiment, the particular bit may indicate whether the logical address is the specific logical address. For example, when the logical address is not the specific logical address, the particular bit may be represented by “0”, and when the logical address is the specific logical address, the particular bit may be represented by “1”. When the write request RQ_WRITE generated and outputted from the host device 400 includes information regarding whether the logical address is the specific logical address, a list of logical addresses set to the specific logical addresses may not be stored in the controller 200 in advance.

FIG. 5B is a flowchart schematically illustrating an operation of a memory system or a data processing system, i.e., the memory system 100 or the data processing system 10 of FIG. 1, in accordance with an embodiment. With reference to FIGS. 1, 2A, 2B, 3, 5A and 5B, a process, in which the write operation and the read operation are performed when the information regarding whether the logical address is the specific logical address is received from the host device 400, will be described in detail below.

Referring to FIG. 5B, at step S2000, the host device 400 may generate a write request RQ_WRITE (LA0) and transmit the generated write request RQ_WRITE (LA0) to the controller 200. Specifically, as described with reference to FIG. 5A, the write request RQ_WRITE (LA0) may include the information on the logical address(e.g., start LA and LA length), which is the target of the write operation, the data, which is the target of the write request, and the information regarding whether the logical address is the specific logical address (e.g., particular bit of “0” or “1”). For example, since the logical address, which is the target of the write request RQ_WRITE (LA0), is the logical address LA0, the “start LA” is represented by 0 and the “LA length” is represented by 1. As shown in FIG. 2B, since the logical address LA0 is the specific logical address, the “particular bit” is “1”.

At step S2100, the controller 200 performs an update operation of the specific mapping table when the logical address corresponding to the write request RQ_WRITE received from the host device 400 is the specific logical address. Specifically, the controller 200 may perform the update operation of the specific mapping table by accessing the specific memory 221 to acquire the specific mapping table, setting a physical address at which data corresponding to the logical address LA0 is to be stored, and adding the mapping information of the logical address LA0. In such a case, as shown in FIG. 2B, a physical address to be mapped to the logical address LA0 assumed to be a physical address PA (1, 0).

At step S2200, the controller 200 generates a write command CMD_WRITE (PA (1, 0)) on the basis of the mapping information of the logical address LA0 included in the specific mapping table and transmits the write command CMD_WRITE (PA (1, 0)) to the nonvolatile memory device 300. At step S2300, the write operation for data requested to be written is performed in the nonvolatile memory device 300. Specifically, the data requested to be written is written in an area of the nonvolatile memory device 300 corresponding to the physical address PA (1, 0). In accordance with an embodiment, the order of step S2100 and step S2200 may be changed. That is, after the data is stored in the nonvolatile memory device 300 (step S2200), the update operation of the specific mapping table may be performed in the controller 200 (step S2100).

Subsequent steps S3000, S4000, S4100, S6100, S7000, S7100, and S7200 may be performed in the same manner as described with reference to FIG. 3. That is, the controller 200 may receive the read request RQ_READ (LA0) from the host device 400 (S3000), and determine whether the logical address LA0, which is the target of the read request RQ_READ (LA0), is the specific logical address (S4000). Specifically, the controller 200 determines whether the logical address LA0 is the specific logical address with reference to the information on the specific logical address stored in an area other than the specific memory 221, and determines that the logical address LA0 is the specific logical address as assumed above. If it is determined that the logical address LA0 is not the specific logical address (S4000, N), the controller 200 transmits the read command CMD_READ (MPT_LA0) to the nonvolatile memory device 300 in order to acquire the mapping information of the logical address LA0 (S6000), thereby acquiring the mapping table MPT_LA0 (S6100).

When it is determined that the logical address LA0 is the specific logical address (S4000, Y), the controller 200 may access the specific memory 221 to acquire the specific mapping table, and acquire the mapping information of the logical address LA0 on the basis of the specific mapping table (S4100). Then, on the basis of the acquired mapping information, the controller 200 generates the read command CMD_READ (PA (1, 0)), and transmits the read command CMD_READ (PA (1, 0)) to the nonvolatile memory device 300 (S7000). The nonvolatile memory device 300 reads data to requested to be read on the basis of the read command CMD_READ (PA (1, 0)) outputted from the controller 200 and transmits the data requested to be read to the controller 200 (S7100). Then, the controller 200 outputs the data requested to be read to the host device 400, so that the read operation may be ended (S7200).

As described above, when the host device 400 generates the write request RQ_WRITE including the information regarding whether the logical address requested to be written is the specific logical address and transmits the write request RQ_WRITE to the controller 200, the controller 200 does not need to receive in advance and store a list of the specific logical addresses, so that the specific mapping table can be freely updated. That is, only the list set in advance is not fixed to the specific logical address and the specific logical address is added or deleted according to necessity (for example, according to a system use pattern of a user), so that operational maintenance of the system becomes more efficient.

While various embodiments have been illustrated and described, it will be understood to those skilled in the art in light of the present disclosure that the embodiments described are examples only. Accordingly, the memory system, the data processing system, and the operating method of the memory system described herein should not be limited based on the described embodiments.

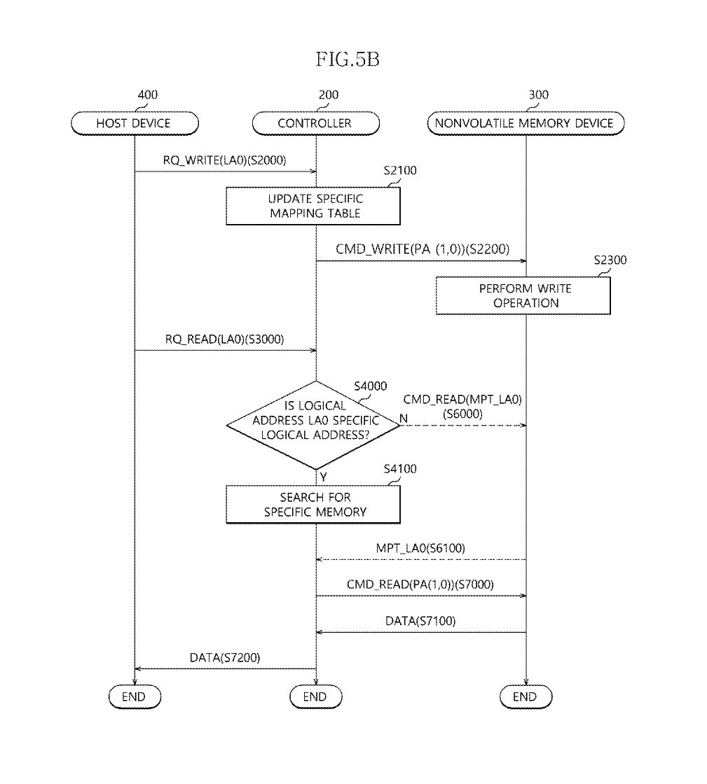

FIG. 6 is a diagram illustrating a data processing system 1000 in accordance with an embodiment. Referring to FIG. 6, the data processing system 1000 may include a host device 1100 and a solid state drive (SSD) 1200.

Referring to FIG. 6, the SSD 1200 may include a controller 1210, a buffer memory device 1220, nonvolatile memory devices 1231 to 123n, a power supply 1240, a signal connector 1250, and a power connector 1260.

The controller 1210 may control general operations of the SSD 1200. The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and the like. The host interface 1211 may interface the host device 1100 and the SSD 1200 according to the protocol of the host device 1100. For example, the host interface 1211 may communicate with the host device 1100 through any one of standard interface protocols, such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-e or PCIe) and universal flash storage (UFS).

The control component 1212 may analyze and process a signal SGL inputted from the host device 1100. The control component 1212 may control operations of internal function blocks according to firmware or software for driving the SSD 1200. The random access memory 1213 may be used as a working memory for driving such firmware or software.

The ECC component 1214 may generate the parity data of data to be transmitted to the nonvolatile memory devices 1231 to 123n. The generated parity data may be stored together with the data in the nonvolatile memory devices 1231 to 123n. The ECC component 1214 may detect an error of the data read out from the nonvolatile memory devices 1231 to 123n, based on the parity data. If a detected error is within a correctable range, the ECC component 1214 may correct the detected error.

The memory interface 1215 may provide control signals such as commands and addresses to the nonvolatile memory devices 1231 to 123n, according to control of the control component 1212. Moreover, the memory interface 1215 may exchange data with the nonvolatile memory devices 1231 to 123n, according to control of the control component 1212. For example, the memory interface 1215 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n, Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be properly terminated when a sudden power-off occurs. The auxiliary power supply 1241 may include at least one capacitor having large capacity.

The signal connector 1250 may be implemented by any of various types of connectors depending on an interface scheme between the host device 1100 and the SSD 1200.

The power connector 1260 may be implemented by any of various types of connectors depending on a power supply scheme of the host device 1100.

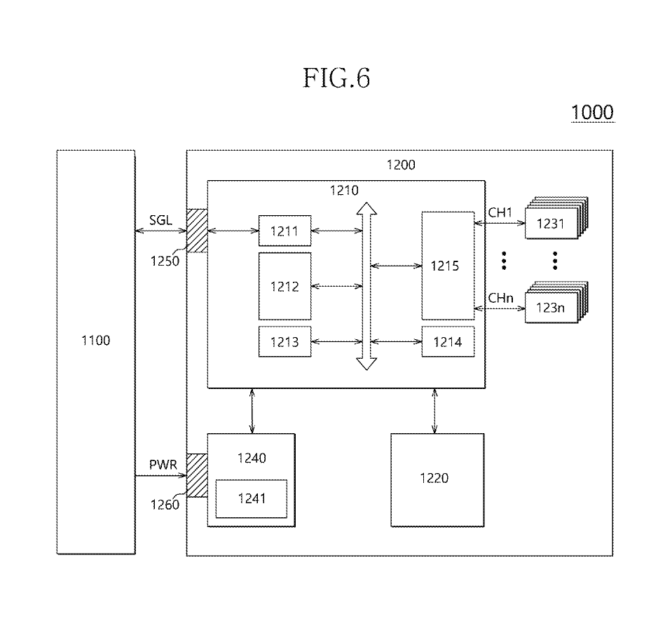

FIG. 7 is a diagram illustrating a data processing system 2000 in accordance with an embodiment. Referring to FIG. 7, the data processing system 2000 may include a host device 2100 and a data storage device 2200.

The host device 2100 may be implemented in the form of a board such as a printed circuit board. Although not shown, the host device 2100 may include internal function blocks for performing functions.

The host device 2100 may include a connection terminal 2110 such as a socket, a slot or a connector. The data storage device 2200 may be mounted to the connection terminal 2110.

The data storage device 2200 may be implemented in the form of a board such as a printed circuit board. The data storage device 2200 may be a memory module or a memory card. The data storage device 2200 may include a controller 2210, a buffer memory device 2220, nonvolatile memory devices 2231 and 2232, a power management integrated circuit (PMIC) 2240, and a connection terminal 2250.

The controller 2210 may control general operations of the data storage device 2200. The controller 2210 may be implemented in the same manner as the controller 1210 shown in FIG. 6.

The buffer memory device 2220 may temporarily store data to be stored in the nonvolatile memory devices 2231 and 2232. Further, the buffer memory device 2220 may temporarily store the data read out from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the data storage device 2200.

The PMIC 2240 may provide the power inputted through the connection terminal 2250, to the inside of the data storage device 2200. The PMIC 2240 may manage the power of the data storage device 2200 according to control of the controller 2210.

The connection terminal 2250 may be coupled to the connection terminal 2110 of the host device 2100. Through the connection terminal 2250, signals such as commands, addresses, data and the like, as well as power may be transferred between the host device 2100 and the data storage device 2200. The connection terminal 2250 may be configured as any of various types depending on an interface scheme between the host device 2100 and the data storage device 2200. The connection terminal 2250 may be disposed on any side of the data storage device 2200.

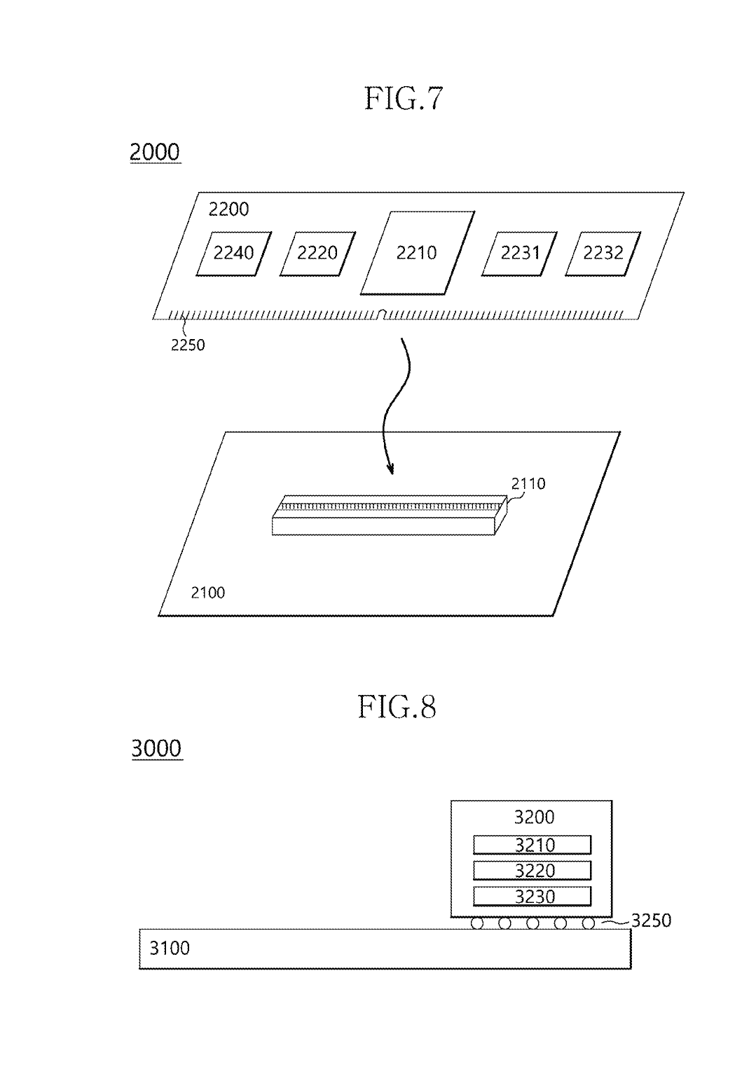

FIG. 8 is a diagram illustrating a data processing system 3000 in accordance with an embodiment. Referring to FIG. 8, the data processing system 3000 may include a host device 3100 and a data storage device 3200.

The host device 3100 may be implemented in the form of a board such as a printed circuit board. Although not shown, the host device 3100 may include internal function blocks for performing functions.

The data storage device 3200 may be implemented in the form of a surface-mounting type package. The data storage device 3200 may be mounted to the host device 3100 through solder balls 3250. The data storage device 3200 may include a controller 3210, a buffer memory device 3220, and a nonvolatile memory device 3230.

The controller 3210 may control general operations of the data storage device 3200. The controller 3210 may be configured in the same manner as the controller 1210 shown in FIG. 6.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as a storage medium of the data storage device 3200.

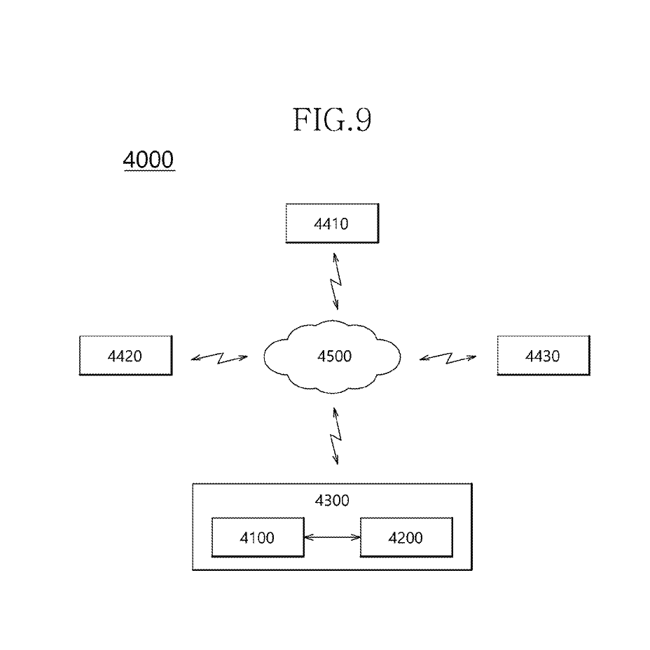

FIG. 9 is a diagram illustrating a network system 4000 in accordance with an embodiment. Referring to FIG. 9, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and a data storage device 4200. The data storage device 4200 may be implemented by the data storage device 100 shown in FIG. 1, the SSD 1200 shown in FIG. 6, the data storage device 2200 shown in FIG. 7 or the data storage device 3200 shown in FIG. 8.

FIG. 10 is a diagram illustrating a nonvolatile memory device 300 included in a data storage device in accordance with an embodiment. Referring to FIG. 10, the nonvolatile memory device 300 may include a memory cell array 310, a row decoder 320, a data read and write (read/write) block 330, a column decoder 340, a voltage generator 350, and control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to the control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to the control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines (or data input/output buffers), based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For still another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control the read, write and erase operations of the nonvolatile memory device 300.

While various embodiments have been illustrated and described, it will be understood to those skilled in the art in light of the present disclosure that the embodiments described are examples only. Accordingly, the present invention is not limited to the described embodiments. Rather, the present invention encompasses the disclosed embodiments, as well as all modifications and variations thereof to the extent they fall within the scope of the claims.

What is claimed is:

1. A memory system comprising:
a nonvolatile memory device including a plurality of memory blocks; and
a controller configured to generate a first mapping table for mapping information between logical addresses of a host device and physical addresses of the nonvolatile memory device and to control the first mapping table to be stored in the memory blocks,
wherein the controller comprises:
a host interface configured to receive from the host device a specific logical address to be written in a second mapping table; and
a specific memory configured to store the second mapping table.

2. The memory system according to claim 1, wherein, when a read request for the specific logical address is received from the host device, the controller performs a read operation corresponding to the read request with reference to the specific memory.

3. The memory system according to claim 1, wherein the specific logical address includes a logical address corresponding to data for driving an operating system of the host device.

4. The memory system according to claim 1, wherein the specific logical address includes a logical address corresponding to data for a user authentication operation of the host device.

5. The memory system according to claim 1, wherein, when an addition request to add a specific logical address is received from the host device, the controller receives mapping information corresponding to the addition request from the nonvolatile memory device and adds the specific logical address to the second mapping table, and
when a deletion request to delete the specific logical address is received from the host device, the controller deletes mapping information corresponding to the deletion request from the second mapping table.

6. The memory system according to claim 1, wherein the controller stores information on the specific logical address in an area other than the specific memory, and
when a read request is received from the host device, the controller determines whether a logical address corresponding to the read request is the specific logical address with reference to the information on the specific logical address.

7. The memory system according to claim 1, wherein the controller includes a read only memory (ROM) in which information on the specific logical address is stored, and
when a read request is received from the host device, the controller determines whether a logical address corresponding to the read request is the specific logical address with reference to the ROM.

8. A data processing system comprising:
a nonvolatile memory device including a plurality of memory blocks;
a host device configured to generate a write request including a logical address corresponding to write data to be stored in the nonvolatile memory device; and
a controller configured to receive the write request from the host device, to generate a first mapping table including mapping information between the logical address and a physical address of the nonvolatile memory device, and to control the first mapping table to be stored in the memory blocks, wherein
the write request includes information regarding whether the logical address is a specific logical address, and
the controller includes a specific memory in which a second mapping table including mapping information of the specific logical address is stored when the logical address is the specific logical address.

9. The data processing system according to claim 8, wherein, when a read request for the specific logical address is received from the host device, the controller performs a read operation corresponding to the read request with reference to the specific memory.

10. The data processing system according to claim 8, wherein the write request includes a bit indicating whether the logical address the specific logical address.

11. The data processing system according to claim 8, wherein the specific logical address includes a logical address corresponding to data for driving an operating system of the host device.

12. The data processing system according to claim 8, wherein the specific logical address includes a logical address corresponding to data for a user authentication operation of the host device.

13. The data processing system according to claim 8, wherein the controller stores information on the specific logical address in an area other than the specific memory, and
when a read request is received from the host device, the controller determines whether a logical address corresponding to the read request is the specific logical address with reference to the information on the specific logical address.

14. The data processing system according to claim 8, wherein the host device generates a read request for read data stored in the nonvolatile memory device, and
the read request includes information regarding whether a logical address corresponding to the read data is the specific logical address.

15. An operating method of a memory system including a controller that generates a first mapping table for mapping information between logical addresses of a host device and physical addresses of a nonvolatile memory device, the nonvolatile memory device including a plurality of memory blocks, the operating method comprising:
receiving, from the host device, a specific logical address to be written in a second mapping table;
writing mapping information of the specific logical address in the second mapping table; and
storing the second mapping table in a specific memory,
wherein the second mapping table is fixed to the specific memory.

16. The operating method according to claim 15, further comprising:
receiving, from the host device, a read request for the specific logical address; and
performing a read operation corresponding to the read request with reference to the specific memory.

17. The operating method according to claim 15, further comprising:
receiving, from the host device, an update request of the second mapping table; and
updating the second mapping table in correspondence to the update request.

18. The operating method according to claim 17, wherein the to update request includes an addition or deletion request to add or delete the specific logical address written in the second mapping table.

19. The operating method according to claim 15, wherein the receiving of the specific logical address comprises:
receiving, from the host device, a write request, which includes a logical address corresponding to write data to be stored in the nonvolatile memory device and information regarding whether the logical address is the specific logical address, and
wherein the operating method further comprises:
determining whether the logical address is the specific logical address.

20. The operating method according to claim 19, wherein the receiving of the write request comprises:
receiving the write request including a bit indicating whether the logical address is the specific logical address.
